(19) United States
(12) Patent Application Publication
(10) Pub. No.: US 2004/0074102 A1
(43) Pub. Date: Apr. 22, 2004

(54) Dryer lid for substrate dryer

(75) Inventor: Yi-Yuan Lin, Taipei (TW)

Correspondence Address: TUNG & ASSOCIATES, 838 W. Long Lake Road, Suite 120, Bloomfield Hills, MI, 48302, US

(73) Assignee: Taiwan Semiconductor Manufacturing Co., Ltd.

(21) Appl. No.: 10/274,651

(22) Filed: Oct. 21, 2002

(51) Int. Cl. F26B 21/06; F26B 25/00; F26B 9/00; F26B 13/00; F26B 13/06

(52) U.S. Cl. 34/78; 34/107; 34/630

(57) ABSTRACT

A dryer lid for a substrate dryer such as a Marangoni-type substrate drying system. The dryer lid includes a lid panel which is mounted on a substrate cleaning tank and has a gasket slot that extends into the bottom surface of the lid panel, around the perimeter thereof. A sealing gasket is seated in the gasket slot. The gasket slot receives the upper edge of a lid frame, the bottom edge of which typically supports a gas shower panel fitted with multiple gas nozzles inside the substrate cleaning tank. Accordingly, the sealing gasket is interposed between the lid frame and the lid panel and seals the junction between those elements to prevent leakage of vaporized IPA and nitrogen drying gases from the cleaning tank during drying of substrates in the cleaning tank.

### FIELD OF THE INVENTION

The present invention relates to systems. for drying semiconductor wafer substrates after cleaning in the fabrication of semiconductor integrated circuits on the substrates. More particularly, the present invention relates to a new and improved, leak-resistant dryer lid for a Marangoni-type substrate drying system.

### BACKGROUND OF THE INVENTION

Generally, the process for manufacturing integrated circuits on a silicon wafer substrate typically involves deposition of a thin dielectric or conductive film on the wafer using oxidation or any of a variety of chemical vapor deposition processes; formation of a circuit pattern on a layer of photoresist material by photolithography; placing a photoresist mask layer corresponding to the circuit pattern on the wafer; etching of the circuit pattern in the conductive layer on the wafer; and stripping of the photoresist mask layer from the wafer. Each of these steps, particularly the photoresist stripping step, provides abundant opportunity for organic, metal and other potential circuit-contaminating particles to accumulate on the wafer surface.

In the semiconductor fabrication industry, minimization of particle contamination on semiconductor wafers increases in importance as the integrated circuit devices on the wafers decrease in size. With the reduced size of the devices, a contaminant having a particular size occupies a relatively larger percentage of the available space for circuit elements on the wafer as compared to wafers containing the larger devices of the past. Moreover, the presence of particles in the integrated circuits compromises the functional integrity of the devices in the finished electronic product. Currently, mini-environment based IC manufacturing facilities are equipped to control airborne particles much smaller than 1.0 μm, as surface contamination continues to be of high priority to semiconductor manufacturers. To achieve an ultra clean wafer surface, particles must be removed from the wafer, and particle-removing methods are therefore of utmost importance in the fabrication of semiconductors.

The most common system for cleaning semiconductor wafers during wafer processing includes a series of tanks which contain the necessary cleaning solutions and are positioned in a “wet bench” in a clean room. Batches of wafers are moved in sequence through the tanks, typically by operation of a computer-controlled automated apparatus. Currently, semiconductor manufacturers use wet cleaning processes which may use cleaning agents such as deionized water and/or surfactants. Other wafer-cleaning processes utilize solvents, dry cleaning using high-velocity gas jets, and a megasonic cleaning process, in which very high-frequency sound waves are used to dislodge particles from the wafer surface. Cleaning systems which use deionized (DI) water currently are widely used in the industry because the systems are effective in removing particles from the wafers and are relatively cost-efficient. Approximately 4.5 tons of water are used for the production of each 200-mm, 16-Mbit, DRAM wafer. In the final process tank, the water and other rinse fluid is removed from the wafer surface using a solvent such as isopropyl alcohol (IPA) . IPA is an organic solvent known to reduce the surface tension of water.

In one type of IPA drying method, wet substrates are moved into a sealed vessel and placed in the processing region of the vessel. An IPA vapor cloud is generated in a vapor-generating region of the vessel and is directed into the processing region, where it removes water from the wafers. This drying technology is highly effective in removing liquid from the wafers, but is not easily adaptable to single vessel systems in which chemical processing, rinsing, and drying can be carried out in a single vessel.

Environmental concerns have given rise to efforts to improve drying technology in a manner that minimizes IPA usage. One such improved drying technology is the Marongoni technique. In one application of the Marongoni technique, an IPA vapor is condensed on top of the rinse water containing the wafers while the wafers are slowly lifted from the processing vessel. The concentration of the dissolved vapor is highest at the wafer surfaces and lower at the regions of the rinse fluid that are spaced from the wafer surfaces. Because surface tension decreases as IPA concentration increases, the surface tension of the water is lowest at the wafer surface where the IPA concentration is highest. The concentration gradient thus results in “Marongoni flow” of the rinse water away from the surfaces of the wafers. Rinse water is thereby stripped from the wafer surfaces, leaving the wafer surfaces dry.

One example of a conventional Marangoni drying system 1 which employs the Marongoni technique to dry substrates is illustrated in cross-section in FIG. 1. The system 1 includes a cleaning tank 2 which contains a supply of DI (deionized) water 3. A dryer lid 10 is fitted in the top of the cleaning tank 2 and includes a top panel 11 which is secured to the upper edge of the cleaning tank 2. A rectangular frame 13 extends downwardly from the top panel 11 into the upper, dry portion 6 of the cleaning tank 2. A gas shower panel 14, provided with multiple gas nozzles 17, as shown in FIG. 2, is provided on the bottom edge of the frame 13. As shown in FIG. 3, multiple fasteners 15 may be used to attach the gas shower panel 14 to the frame 13.

In a substrate drying process using the Marangoni system 1, a substrate 4 is first rinsed in the substrate cleaning tank 2 using DI water 3. Next, a gas mixture 5 which typically includes nitrogen gas and vaporized IPA (isopropyl alcohol) is introduced into the substrate cleaning tank 2. A meniscus-shaped gradient is formed along the interface between the surface of the substrate 4 and the DI water 3, and as the substrate 4 is removed from the substrate cleaning tank 2, the water flows along the meniscus portion and is thereby removed from the substrate 4, with no water remaining on the substrate 4 upon complete removal of the substrate 4 from the tank 2.

Referring again to FIG. 3, the top panel 11 is attached to the upper edge of the frame 13 typically using adhesive 18. During the drying operation of the conventional Marangoni system 1 heretofore described, the gas mixture 5 tends to leak through the adhesive 18 and from the dryer lid 10 between the top panel 11 and the frame 13. As a result, inadequate quantities of the gas mixture 5 remain in the dry portion 6 of the cleaning tank 2, and the substrate 4 dries incompletely. This causes the formation of water marks in deep sub-micron trenches formed in the substrate 4 during the course of IC fabrication. Consequently, the yield of devices on the substrates 4 is adversely affected, and the affected substrates 4 must be scrapped. Accordingly, a new and improved dryer lid for a Marongoni dryer is needed for preventing leakage of drying IPA and nitrogen gases from the dryer through the dryer lid and maintaining adequate quantities of the IPA and nitrogen gas mixture in the dryer throughout drying of substrates after washing in order to prevent formation of water marks in the devices formed on the substrates.

An object of the present invention is to provide a new and improved, leakage-resistant dryer lid for a Marangoni dryer.

Another object of the present invention is to provide a new and improved dryer lid which prevents or resists leakage of drying gases from a Marangoni dryer during the drying of substrates.

Still another object of the present invention is to provide a new and improved, leak-resistant dryer lid for a Marangoni dryer for substrates, which dryer lid includes a top panel provided with a gasket slot into which is inserted a sealing gasket and which receives the upper edge of a lid frame typically having a gas shower panel attached thereto.

Yet another object of the present invention is to provide a new and improved dryer lid for enhancing the drying efficacy of a Marangoni dryer.

A still further object of the present invention is to provide a new and improved dryer lid which facilitates enhanced yield of devices on substrates cleaned and dried in a Marangoni dryer.

### SUMMARY OF THE INVENTION

In accordance with these and other objects and advantages, the present invention is directed to a new and improved dryer lid for a substrate dryer such as a Marangoni-type substrate drying system. The dryer lid includes a lid panel which is mounted on a substrate cleaning tank and has a gasket slot that extends into the bottom surface of the lid panel, around the perimeter thereof. A sealing gasket is seated in the gasket slot. The gasket slot receives the upper edge of a lid frame, the bottom edge of which typically supports a gas shower panel fitted with multiple gas nozzles inside the substrate cleaning tank. Accordingly, the sealing gasket is interposed between the lid frame and the lid panel and seals the junction between those elements to prevent leakage of vaporized IPA and nitrogen drying gases from the cleaning tank during drying of substrates in the cleaning tank.

### BRIEF DESCRIPTION OF THE DRAWINGS

The invention will now be described, by way of example, with reference to the accompanying drawings, in which:

FIG. 1 is a cross-sectional view of a cleaning tank of a typical conventional Marangoni dryer;

FIG. 2 is a bottom perspective view of a standard dryer lid element of a conventional Marangoni dryer;

FIG. 3 is an inverted side view of the standard dryer lid of the conventional Marangoni dryer;

FIG. 4 is a bottom view of the standard dryer lid of the conventional Marangoni dryer;

FIG. 5 is a bottom perspective view of a dryer lid according to the present invention;

FIG. 6 is an inverted side view, partially in section, of a dryer lid according to the present invention;

FIG. 7a is a bottom view of a lid panel component of the dryer lid according to the present invention;

FIG. 7b is a top view of the lid frame component of the dryer lid according to the present invention, with the lid panel removed from the lid frame;

FIG. 7c is a bottom view of a gas shower panel component of the dryer lid according to the present invention;

FIG. 8 is a side view of the lid frame component of the dryer lid according to the present invention;

FIG. 9 is a bottom view of the dryer lid according to the present invention; and

FIG. 10 is a cross-sectional view of a cleaning tank of a Marangoni dryer, in implementation of the present invention.

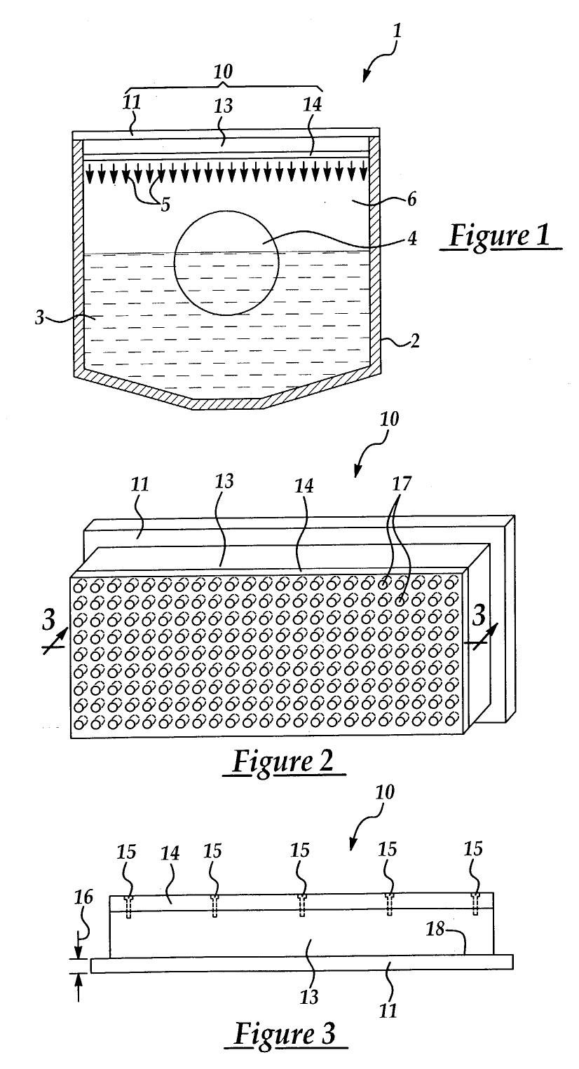

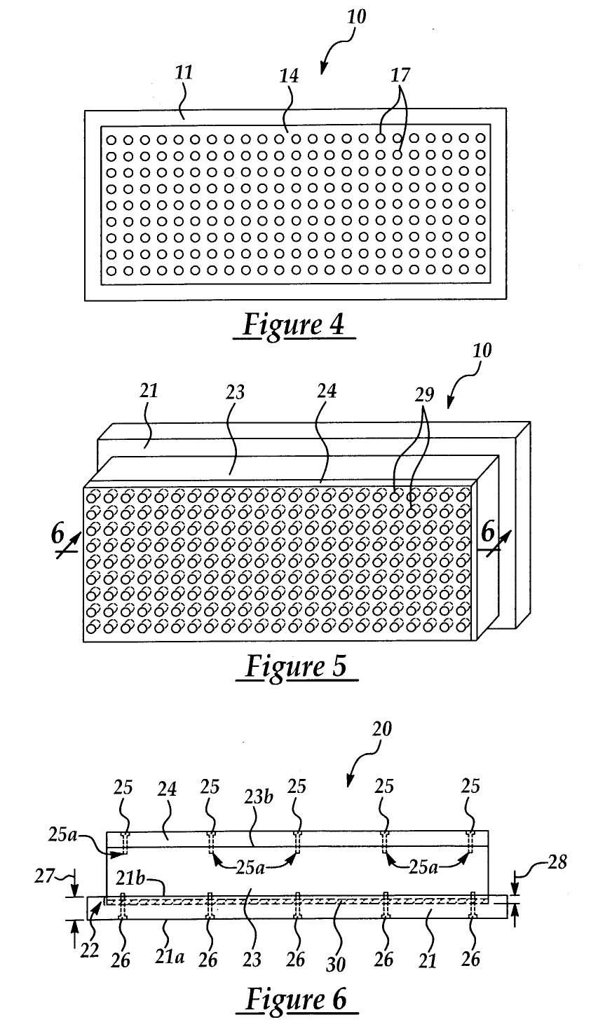

### DESCRIPTION OF THE PREFERRED EMBODIMENTS

The present invention is generally directed to a new and improved dryer lid for a substrate dryer such as a Marangoni-type substrate drying system. The dryer lid of the present invention prevents leakage of drying gases, such as vaporized IPA and nitrogen gas, from a cleaning tank for cleaning and drying substrates during the course of fabricating integrated circuits on the substrates. Because the drying gases are maintained at a high concentration in the cleaning tank, enhanced drying of the substrates in the cleaning tank is achieved, thereby preventing the formation of water marks in device features being fabricated on the substrates.

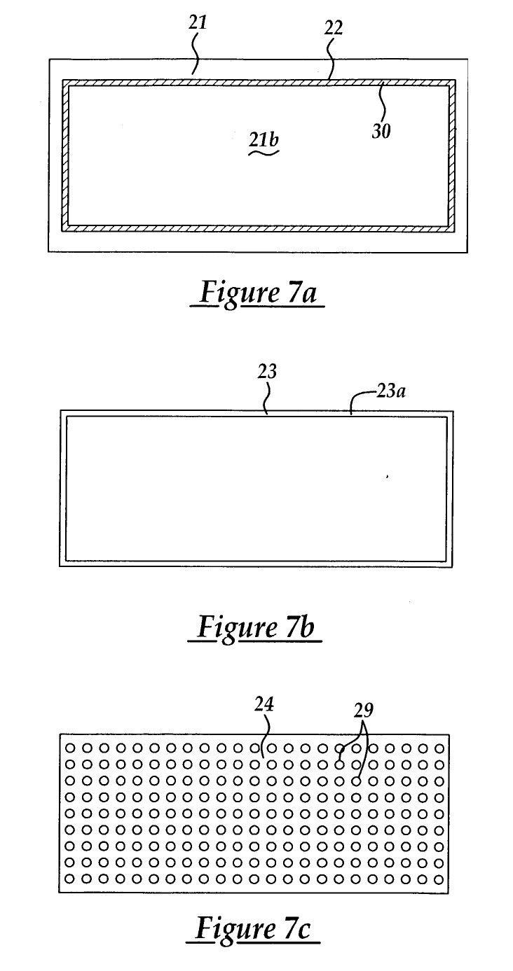

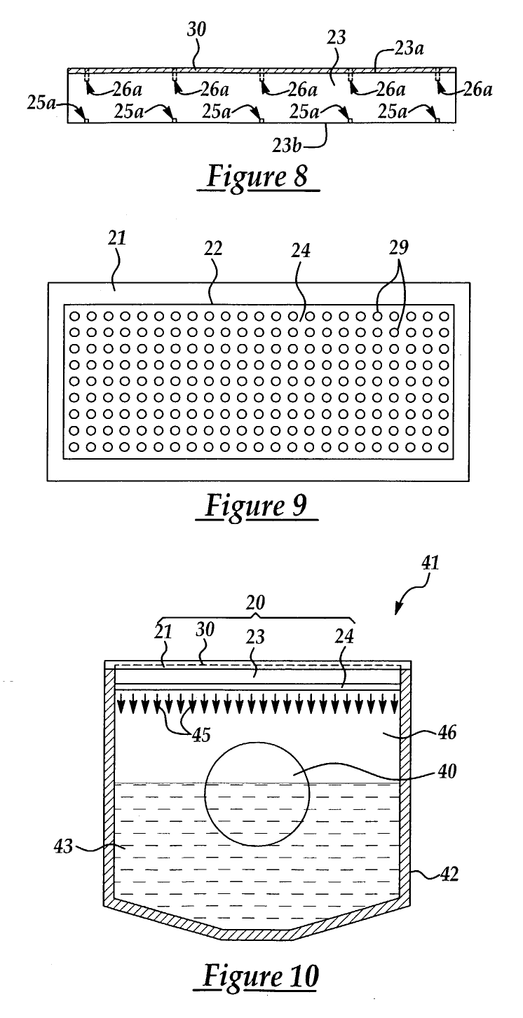

Referring initially to FIGS. 5-7c, an illustrative embodiment of the dryer lid of the present invention is generally indicated by reference numeral 20 and is typically used in conjunction with a Marangoni-type substrate drying system which is well-known by those skilled in the art. However, it is understood that the dryer lid 20 may be equally applicable to other substrate drying systems known by those skilled in the art. The dryer lid 20 includes a typically elongated, rectangular lid panel 21 having an upper surface 21a and a lower surface 21b, as shown in the inverted side view of FIG. 6. As further shown in FIG. 6, the lid panel 21 has a thickness 27 of typically about 0.5 cm to about 2.0 cm. A continuous gasket slot 22, having a slot depth 28 of typically about 0.5 cm to about 0.6 cm, extends into the lower surface 21b of the lid panel 21, adjacent to the perimeter of the lid panel 21. The gasket slot 22 is sized and configured to receive the upper edge 23a of an elongated, rectangular lid frame 23, as hereinafter further described. A sealing gasket or other seal 30, which may be constructed of polytetrafluoroethylene, or TEFLON®, is seated in the sealing gasket 30. Alternatively, the sealing gasket 30 may be provided on the upper edge 23a of the lid frame 23, as shown in FIG. 8. Accordingly, when the upper edge 23a of the lid frame 23 is inserted in the gasket slot 22, the sealing gasket 30 is interposed between the lid panel 21 and the upper edge 23a of the lid frame 23. Multiple fastener openings 26a, which extend into the upper edge 23a of the lid frame 23 around the perimeter thereof, receive respective lid panel fasteners 26 (FIG. 6) which are threaded first through fastener openings (not shown ) provided in the lid panel 21 and then into the respective fastener openings 26a of the lid frame 23, as shown in FIG. 6, to fasten the lid panel 21 on the lid frame 23 and seal the sealing gasket 30 between the lid frame 23 and the lid panel 21. It is understood that any alternative type of fastening mechanism known by those skilled in the art, including adhesives or clamps, for example, may be used to fasten the lid panel 21 on the lid frame 23.

A typically elongated, rectangular gas shower panel 24, provided with multiple gas nozzles 29, is mounted on the lower edge 23b of the lid frame 23. Accordingly, multiple spaced-apart fastener openings 25a extend into the lower edge 23b of the lid frame 23, around the perimeter thereof. As shown in FIG. 6, shower panel fasteners 25 are threaded first through fastener openings (not shown) extending through the gas shower panel 24 and then into the fastener openings 25a of the lid frame 23 to mount the gas shower panel 24 on the lower edge 23b of the lid frame 23. Alternative techniques known by those skilled in the art may be used to mount the gas shower panel 24 on the lid frame 23.

Referring next to FIG. 10, the dryer lid 20 of the present invention is mounted on a cleaning tank 42 of a Marangoni dryer 41, for example. Accordingly, the sealing gasket 30 is interposed between the lid panel 21 and the lid frame 23 to provide a gas-tight seal between the exterior of the cleaning tank 42 and the dry portion 46 inside the cleaning tank 42. A substrate 40 is first rinsed in the substrate cleaning tank 42 using DI water 43. Next, a drying gas mixture 45 which typically includes nitrogen gas and vaporized IPA (isopropyl alcohol) is introduced into the substrate cleaning tank 42. A meniscus-shaped gradient is formed along the interface between the surface of the substrate 40 and the DI water 43, and as the substrate 40 is removed from the substrate cleaning tank 42, the water flows along the meniscus portion and is thereby removed from the substrate 40, with no water remaining on the substrate 40 upon complete removal of the substrate 40 from the cleaning tank 42. Due to the presence of the sealing gasket 30, the mixed drying IPA vapor and nitrogen gas 45 is highly concentrated in the upper, dry portion 46 of the cleaning tank 42, since the drying gas 45 is incapable of leaking from the dry portion 46 to the exterior of the dryer 41 through the dryer lid 20. Consequently, complete drying of the substrate 40 is accomplished, preventing the formation of water marks in device features being fabricated on the substrate 40.

While the preferred embodiments of the invention have been described above, it will be recognized and understood that various modifications can be made in the invention and the appended claims are intended to cover all such modifications which may fall within the spirit and scope of the invention.

What is claimed is:

1. A dryer lid for a substrate dryer, comprising:
a lid panel having a slot;
a seal at least partially inserted in said slot;
a lid frame engaging said seal; and
an attachment mechanism attaching said lid panel to said lid frame.

2. The dryer lid of claim 1 wherein said lid panel has a thickness of from about 0.5 cm to about 2 cm.

3. The dryer lid of claim 1 wherein said slot has a depth of from about 0.5 cm to about 0.6 cm.

4. The dryer lid of claim 3 wherein said lid panel has a thickness of from about 0.5 cm to about 2 cm.

5. The dryer lid of claim 1 wherein said seal comprises a gasket.

6. The dryer lid of claim 5 wherein said lid panel has a thickness of from about 0.5 cm to about 2 cm.

7. The dryer lid of claim 5 wherein said slot has a depth of from about 0.5 cm to about 0.6 cm.

8. The dryer lid of claim 7 wherein said lid panel has a thickness of from about 0.5 cm to about 2 cm.

9. The dryer lid of claim 5 wherein said gasket comprises polytetrafluoroethylene.

10. The dryer lid of claim 9 wherein said lid panel has a thickness of from about 0.5 cm to about 2 cm.

11. The dryer lid of claim 9 wherein said slot has a depth of from about 0.5 cm to about 0.6 cm.

12. The dryer lid of claim 11 wherein said lid panel has a thickness of from about 0.5 cm to about 2 cm.

13. A dryer lid for a substrate dryer, comprising:
a lid panel having a slot;
a seal at least partially inserted in said slot;
a lid frame at least partially inserted in said slot and engaging said seal; and
a plurality of fasteners extending through said lid panel and into said lid frame for attaching said lid panel to said lid frame.

14. The dryer lid of claim 13 wherein said lid panel has a thickness of from about 0.5 cm to about 2 cm.

15. The dryer lid of claim 13 wherein said slot has a depth of from about 0.5 cm to about 0.6 cm.

16. The dryer lid of claim 13 wherein said seal comprises a polytetrafluoroethylene gasket.

17. A dryer lid for a substrate dryer, comprising:
a lid panel having a slot extending adjacent to a perimeter of said lid panel;
a seal at least partially inserted in said slot;
a lid frame engaging said seal; and
an attachment mechanism attaching said lid panel to said lid frame.

18. The dryer lid of claim 17 wherein said lid panel has a thickness of from about 0.5 cm to about 2 cm.

19. The dryer lid of claim 17 wherein said slot has a depth of from about 0.5 cm to about 0.6 cm.

20. The dryer lid of claim 17 wherein said seal comprises a polytetrafluoroethylene gasket.
